(19) United States
(12) Patent Application Publication
(10) Pub. No.: US 2009/0280772 A1
(43) Pub. Date: Nov. 12, 2009

(54) APPARATUS AND METHOD FOR SENDING AN ADDITIONAL MESSAGE TO A SUBSCRIBER TERMINAL

(76) Inventor: Vladimir Alperovich, Plano, TX (US)

Correspondence Address: ERICSSON INC., 6300 LEGACY DRIVE, M/S EVR 1-C-11, PLANO, TX, 75024, US

(21) Appl. No.: 12/115,942

(22) Filed: May 6, 2008

(51) Int. Cl. H04M 11/00

(52) U.S. Cl. 455/406

(57) ABSTRACT

An apparatus and method for sending of additional message, such as advertising content, with the account balance message or data to a subscriber terminal.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The present invention is related to the field of telecommunication, more specifically to the field of prepaid services where an account balance message is generated for the user. The following abbreviations shall have the following meanings:

IN—Intelligent Network

IP—Intelligent Peripheral

GMSC—Gateway MSC

GSM—System for Global Communications

SCP—Service Control Point

USSD—Unstructured Supplementary Service Data

USSD is defined within the GSM standard in the documents GSM 02.90 (USSD Stage 1) and GSM 03.90 (USSD Stage 2). USSD is a session oriented technology, whereas SMS is a store-and-forward, transaction-oriented technology. Turnaround response times for interactive applications are shorter for USSD than SMS because of the session-based feature of USSD. In operation, USSD is used to send text between the user and some application. USSD is a trigger rather than an application itself. However, it enables other applications such as prepaid services. In operation, it is not possible to bill for USSD directly, but instead bill for the application associated with the use of USSD such as circuit switch data, SMS, or prepaid.

Conventional prepaid systems used in wireless telecommunications systems generate an account balance message or data to the user after each call and after each text message is send or received. A typical message is as follows: “Charges for the last call were $1.15 your balance is $40.00”.

### BRIEF SUMMARY OF THE INVENTION

The present invention facilitates the sending of an additional message, such as advertising content, with the account balance message or data from a node in an IN to a subscriber terminal. For example, such additional message may be similar to the following: “The account balance was brought to you by Shrek 4 in theaters April 1”. With the present invention, the additional message may vary based on market, location and subscriber profile. Advertising accounts may be set up to set a fixed number of messages per sponsor.

### BRIEF DESCRIPTION OF THE SEVERAL VIEWS OF THE DRAWING

In the following section, the invention will be described with reference to exemplary embodiments illustrated in the figures, in which:

FIG. 1 is a diagram of a wireless telecommunications system which implements the present invention; and

FIG. 2 is a flow chart of the method of the present invention.

### DETAILED DESCRIPTION OF THE INVENTION

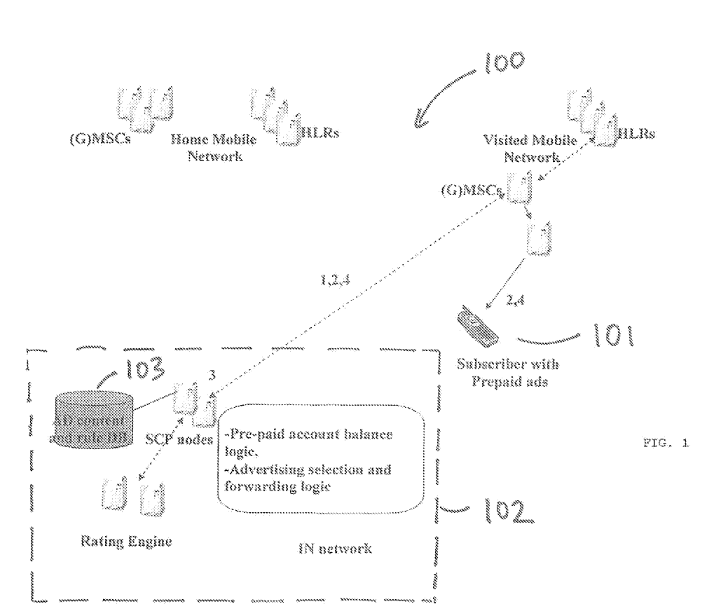

As seem in FIG. 1, using the apparatus, 100, of the present invention, a user of a prepaid telephone, terminal or user equipment 101 (referred to as a “terminal”), makes a call or sends a text message using the terminal. Immediately after the call is complete the subscriber terminal receives an account balance message or data from a node within the IN. After receiving the account balance message or data, the subscriber terminal receives an additional message, such as an advertising message. The additional message may vary from call to call, or the same message may be received. As seen in FIG. 1,

1. An indication is sent to the IN 102 that the call from subscriber terminal 101 is complete;

2. An account balance message or data is sent to the subscriber terminal 101 from IN 102;

3. Rules, or logic, such as Ad-logic, is applied to determine the content of the additional message based on rules maintained in database server 103; and

4. Content from database server 103 is sent to the subscriber terminal 101.

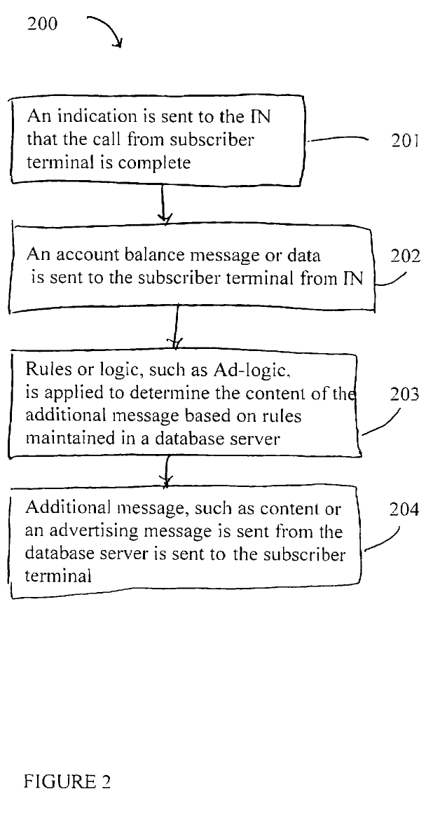

The method 200 of the present invention is provided in FIG. 2. In step 201, an indication is sent to the IN that the call from subscriber terminal is complete. In step 202, an account balance message or data is sent to the subscriber terminal from IN. In step 203, logic, such as ad-logic, is applied to determine the content of the additional message based on rules maintained in database server. In step 204, the additional message, such as the advertising message from database server is sent to the subscriber terminal.

The apparatus and method further comprises sending an additional message according to the rules or logic, wherein the rules or logic are maintained in a database server of the IN. As seen in FIG. 1, the content of the additional message is maintained in and sent from the database server. The content of the additional message can be based on market criteria, the location of the subscriber terminal or a subscriber profile. The additional message can be an advertising message, the content and/or number of advertising messages sent per sponsor being based on criteria from an advertising account. The number of advertising messages sent in a certain period can be a fixed number of messages per sponsor.

The present invention advantageously provides an additional source of revenue to the operator of a wireless network as millions of messages are sent to subscribers annually. These messages, if charged to advertising sponsors, would provide a significant source of revenue for a mobile operator.

As will be recognized by those skilled in the art, the innovative concepts described in the present application can be modified and varied over a wide range of applications. Accordingly, the scope of patented subject matter should not be limited to any of the specific exemplary teachings discussed above, but is instead defined by the following claims.

What is claimed:

1. An apparatus for use in a wireless telecommunications system, comprising
a node within an Intelligent Network (IN) adapted to receive an indication that a call of the subscriber terminal has been completed, the IN adapted to send an account balance data to the subscriber terminal; and
a database server within the IN adapted to maintain rules regarding whether to send an additional message to the subscriber terminal, and if an additional message is to be sent, the additional message to be sent.

2. The apparatus of claim 1, further comprising means for rating the content of the additional message.

3. The apparatus of claim 1, for use in combination with an Unstructured Supplementary Service Data (USSD) based prepaid system.

4. The apparatus of claim 1, wherein the additional message is an advertising message.

5. The apparatus of claim 1, in combination with a subscriber terminal.

6. The apparatus of claim of claim 1, wherein the additional message is based on market criteria.

7. The apparatus of claim 1, wherein the additional message is based on the location of the subscriber terminal.

8. The apparatus of claim 1, wherein the additional message is based on a subscriber profile.

9. The apparatus of claim 1, wherein the additional message is an advertising message, the content and/or number of advertising messages sent per sponsor being based on criteria from an advertising account.

10. The apparatus of claim 9, wherein the number of advertising messages sent in a certain period is a fixed number of messages per sponsor.

11. A terminal for use in a wireless telecommunications system, comprising
a transmitter for sending an indication to a node of an Intelligent Network (IN) that a call from the terminal has been completed, wherein the terminal is adapted to receive from the IN account balance data; and
the terminal adapted to receive an additional message from the IN node.

12. The terminal of claim 11, wherein the terminal is adapted for use in an Unstructured Supplementary Service Data (USSD) based prepaid system.

13. The terminal of claim 11, wherein the additional message is an advertising message.

14. A method for use in a wireless telecommunications system, comprising the steps of:
sending an indication to a node in an Intelligent Network (IN) that the call from a subscriber terminal is complete;
sending an account balance message or data to the subscriber terminal from IN; and
applying rules or logic to determine whether an additional message is to be sent with or after the account balance message or data.

15. The method of claim 14, further comprising the step of sending an additional message according to the rules or logic.

16. The method of claim 15, wherein the rules or logic are maintained in a database server of the IN.

17. The method of claim 15, wherein the content of the additional message is maintained in and sent from the database server.

18. The method of claim 15, wherein the additional message is based on market criteria.

19. The method of claim 15, wherein the additional message is based on the location of the subscriber terminal.

20. The method of claim 15, wherein the additional message is based on a subscriber profile.

21. The method of claim 15, wherein the additional message is an advertising message, the content and/or number of advertising messages sent per sponsor being based on criteria from an advertising account.

22. The method of claim 15, wherein the number of advertising messages sent in a certain period is a fixed number of messages per sponsor.
